(19) United States
(12) Patent Application Publication
(10) Pub. No.: US 2014/0292592 A1
(43) Pub. Date: Oct. 2, 2014

(54) ANNULAR VEHICLE WITH DIPOLE ANTENNA

(71) Applicant: GO SCIENCE GROUP LTD., Tortola (VG)

(72) Inventors: Harry George Dennis Gosling, Bristol (GB); Arran James Holloway, Bristol (GB)

(73) Assignee: GO SCIENCE GROUP LTD., Tortola (VG)

(21) Appl. No.: 14/360,150

(22) PCT Filed: Nov. 22, 2012
(86) PCT No.: PCT/GB2012/052887

§ 371 Date: May 22, 2014

(30) Foreign Application Priority Data
Nov. 25, 2011 (GB) 1120350.2

(51) Int. Cl. H01Q 1/04; H01Q 1/34; H01Q 9/16

(52) U.S. Cl. CPC H01Q 1/04; H01Q 9/16; H01Q 1/34
USPC 343/709

(57) ABSTRACT

An annular vehicle having a body which defines a body axis and appears substantially annular when viewed along the body axis. The interior of the annulus defines a duct which is open at both ends. The vehicle includes an electric field (EF) coupled dipole antenna arrangement for electro-magnetic communications, which includes at least one dipole antenna. The vehicle is used as a node in an underwater communications system for communicating with other node(s) using their EF coupled dipole antenna arrangements. The electric field coupled dipole antenna arrangement can provide communications with lower latency than systems employing acoustic communications. The annular body provides good separation for electrodes of the EF coupled dipole antenna arrangement disposed around the body.

### FIELD OF THE INVENTION

The present invention relates to communications equipment in an annular vehicle.

### BACKGROUND OF THE INVENTION

An annular vehicle typically has an outer hull which defines a hull axis and appears substantially annular when viewed along the hull axis, the interior of the annulus defining a duct which is open at both ends.

The annular vehicle may be a submersible vehicle. When the vehicle is submerged in water (or any other liquid), the liquid may flood the duct. The term submersible is used here to refer to surface vehicles which are only partly submerged, as well as vehicles which are fully submerged in the liquid. A submersible annular vehicle is described in WO 2007/045887. It is desirable to provide a wireless communications system for an annular vehicle.

Underwater communications systems have traditionally been based on acoustic techniques, typically using hydrophones. Underwater communications are generally more difficult than land-based communications for several reasons. Underwater communications can be subject to significant multi-path propagation, leading to interference and phase shifting. The underwater signal can also be subject to strong attenuation over longer distances. Acoustic underwater communications are generally unsuitable for high data rates. The underwater channels also typically provide small exploitable bandwidths, and these channels can exhibit time variations and Doppler effects due to motions in the water medium, e.g. the moving surface. Furthermore, the high latency of underwater communications makes some tasks, e.g. synchronisation of clocks, difficult.

### SUMMARY OF THE INVENTION

A first aspect of the invention provides an annular vehicle having a body which defines a body axis and appears substantially annular when viewed along the body axis, the interior of the annulus defining a duct which is open at both ends, and an electric field coupled dipole antenna arrangement for electro-magnetic communications which includes at least one dipole antenna.

A second aspect of the invention provides an underwater communications system comprising a plurality of nodes, wherein each node is an annular vehicle in accordance with the first aspect of the invention, and wherein each node is operable to communicate with at least one other node using their electric field coupled dipole antenna arrangements.

A third aspect of the invention provides a method of operating an underwater communications system comprising a plurality of nodes, at least some of the nodes being annular vehicles in accordance with the first aspect of the invention, the method comprising making electro-magnetic communications between the nodes using their electric field coupled dipole antenna arrangements.

The invention is advantageous in that the electric field (EF) coupled dipole antenna arrangement can provide communications with lower latency than systems employing acoustic communications. For example, the latency of the communications (i.e. the time from when a first node transmits and a second node receives the transmission) can be reduced by up to around 200 times as compared with traditional acoustic communications. This is particularly beneficial where the communications may be used to transfer synchronisation signals, as communications with high latency would be unsuitable for this purpose. The data transfer rate achievable using EF communications may also be higher than with acoustics, although this increase may be marginal in some circumstances.

Use of the EF coupled dipole antenna arrangement provides excellent synergy with the annular vehicle. The annular body may provide good separation for electrodes of the EF coupled dipole antenna arrangement disposed around the body. Although means for propulsion, for example, may be disposed within the duct there may also be regions free of electro-magnetic sources within the duct. By positioning the electrodes around the annular body with a region substantially free of electro-magnetic sources between the electrodes, the antenna arrangement may be designed to avoid electro-magnetic interference effects.

Preferably, the vehicle is a submersible and is configured such that when the vehicle is submerged in a liquid, the liquid floods the duct. The liquid may be water. The reduced wavelength in water makes low frequency (of the order of 10 kHz) more practical underwater due to the reduced separation distance required between nodes. Fresh water has a higher impedance than sea water and so the communications may be more reliable in fresh water. However, the annular vehicle may have particular aptitude for deep sea water operations. Alternatively, the vehicle may be an airborne vehicle in which case the fluid filling the duct would be air.

At least one dipole antenna may have separated electrodes disposed on opposite sides of the duct. In this context ‘opposite’ is not intended to be limited to diametric opposition, although the electrodes may, of course, be arranged diametrically opposed. The electrodes separation is preferably at least 120 degrees with respect to the vehicle axis.

The vehicle preferably has no electronics equipment disposed directly between the electrodes. Any such equipment could be an electro-magnetic source which could interfere with the antenna reception/transmission.

The electrodes of the at least one dipole antenna may be conformal with the vehicle body. Conformal electrodes would reduce drag of the moving vehicle, as compared with electrodes projecting outwardly from the vehicle body shape.

The electrodes of the at least one dipole antenna may be removable. Removable electrodes allow for ease of maintenance and/or repair of the electrodes.

The electrodes of the at least one dipole antenna may be covered by a dielectric material. The dielectric material may have an impedance selected to substantially match an impedance of a medium in which the vehicle is intended to operate. For example, the impedance of sea water varies with salinity. The dielectric material may be a plastics material, for example, and may be provided as a cap, or cover, over the respective dipole electrodes.

The at least one dipole antenna may have a coaxial cable extending substantially circumferentially around the duct. The coaxial cable may be shielded. The coaxial cable connects the electrodes to the antenna transmit/receive electronics.

The dipole antenna arrangement may include a plurality of dipole antennas.

The dipole antenna arrangement may include at least two substantially parallel dipole antennas.

Additionally, or alternatively, the dipole antenna arrangement may include at least two substantially orthogonal dipole antennas. For example, orthogonal dipole receive antennas may provide the capability for three-dimensional EF sensing.

The dipole antenna arrangement may include at least one transmitter antenna, and/or at least one receiver antenna, and/or at least one transceiver antenna, and/or at least one transmitter-receiver antenna.

The dipole antenna arrangement may include one or more dipole antennas disposed at an end of the duct. Mounting the dipole antenna(s) at an end of the duct can be beneficial, particularly where electronics equipment is disposed generally centrally along the body axis of the vehicle. This helps to minimise electro-magnetic interference effects of the electronics equipment on the dipole antenna(s).

Positioning the dipole antenna(s) at an end of the vehicle may be beneficial as it can be desirable to ‘fly’ the vehicle into a soft substrate so as to become partially embedded in the substrate. For example, where the vehicle is a submersible it may be desirable to fly the vehicle into the sea bed (or equivalent in fresh water, e.g. lake bed or river bed). Communications via the dipole antenna arrangement may be made over longer distances through the sea bed channel than through the lossy water channel.

The body axis may define a longitudinal axis in the direction of forward travel of the vehicle, and the dipole antenna arrangement may include one or more dipole antennas disposed at the forward end of the vehicle.

A least part of the vehicle body may be swept with respect to the body axis. The swept body may exhibit improved lift/drag performance as compared with an un-swept vehicle.

The swept annular body may form a pair of diametrically opposed apices at each end of the vehicle. Each pair of diametrically opposed apices may be spaced by a distance of approximately ¼ wavelength. For example, the diametrically opposed apices may be spaced by a distance of approximately 0.1 m to 1 m, preferably approximately 0.5 m.

The apices may provide particularly suitable locations for positioning the electrodes of the dipole antenna arrangement. For example, each dipole of the antenna arrangement may be associated with a respective pair of diametrically opposed apices, such that the separated electrodes of each dipole are disposed at a respective apex of the pair of apices. The electrodes at the diametrically opposed apices are, by definition, separated by the diameter of the duct.

The annular body may be swept such that the diametrically opposed apices at each end of the vehicle are oriented orthogonally. This may be achieved through a ‘double swept’ or ‘chevron’ design of the annular body. At each end of the vehicle, the annular body will define a first and second pairs of diametrically opposed apices. The first pair of apices will have an interior angle less than 180 degrees, whereas the second pair of apices will have an interior angle greater than 180 degrees, i.e. a re-entrant angle such that the apices face inwardly towards the vehicle body. The first and second pairs of apices will be oriented orthogonally. The other end of the annular body will also feature two pairs of orthogonal diametrically opposed apices, such that each inwardly facing apex faces towards an outwardly facing apex at the other end of the vehicle.

The double swept annular body has particular synergy with the electrode positioning of the dipole antenna arrangement, as it becomes possible to arrange two orthogonal dipoles at one end, or at both ends, of the vehicle. The body axial spacing of the apex pairs at each end of the vehicle may beneficially provide sufficient spacing between two dipole antennas disposed at the same end of the vehicle.

The dipole antenna arrangement may be configured for electro-magnetic communications at a carrier frequency in the range 10 kHz to 1000 kHz, preferably in the range 50 kHz to 100 kHz.

The vehicle may further comprise a propulsion system. The propulsion system may be used to drive the vehicle forwards and/or backwards, and/or in rotation about its body axis. The vehicle may be a glider. The glider may be powered or un-powered.

In the underwater communications system of the second aspect of the invention, the plurality of nodes may include at least one static node on the sea bed and/or at least one swimming node.

In the method of operating an underwater communications system according to the third aspect of the invention, the plurality of nodes may include a plurality of static nodes on the sea bed, and the method may further comprise making communications between the static nodes via a signal path predominantly through the sea bed.

The plurality of nodes may include at least one static node on the sea bed and at least one swimming node, and the method may further comprise making communications between the static node and the swimming node via a signal path predominantly through the sea water.

The plurality of nodes may include at least one swimming node and at least one above water surface node, and the method may further comprise making communications between the swimming node and the surface node via a signal path that includes an air propagation path.

The plurality of nodes may include at least one static node on the sea bed, and the method may further comprise positioning the static node on the sea bed by flying the annular vehicle into the sea bed so as to be partially embedded in the sea bed.

The method may further comprise deploying the nodes from a surface vessel, and preferably subsequently recovering the nodes to the vessel.

### BRIEF DESCRIPTION OF THE DRAWINGS

Embodiments of the invention will now be described with reference to the accompanying drawings, in which:

FIG. 1 illustrates an annular vehicle having an electric field (EF) coupled dipole antenna;

FIG. 2 illustrates an end view of the annular vehicle;

FIG. 3 illustrates a side section view along A-A in FIG. 2;

FIG. 4 illustrates a plan section view along B-B in FIG. 2;

FIG. 5 illustrates a side section view through another annular vehicle having an EF coupled dipole antenna;

FIG. 6 illustrates schematically control electronics for operating the dipole antenna as a transmitter;

FIG. 7 illustrates schematically control electronics for operating the dipole antenna as a receiver;

FIG. 8 illustrates schematically control electronics for operating the dipole antenna as a selective transmitter/receiver;

FIGS. 9 to 12 illustrate the annular vehicle being used as a node in an underwater communications system and making communications with other nodes of the system via various paths; and

FIGS. 13 to 16 illustrate variants of the annular vehicle of FIG. 1 having a plurality of dipole antennas in various arrangements.

### DETAILED DESCRIPTION OF EMBODIMENT(S)

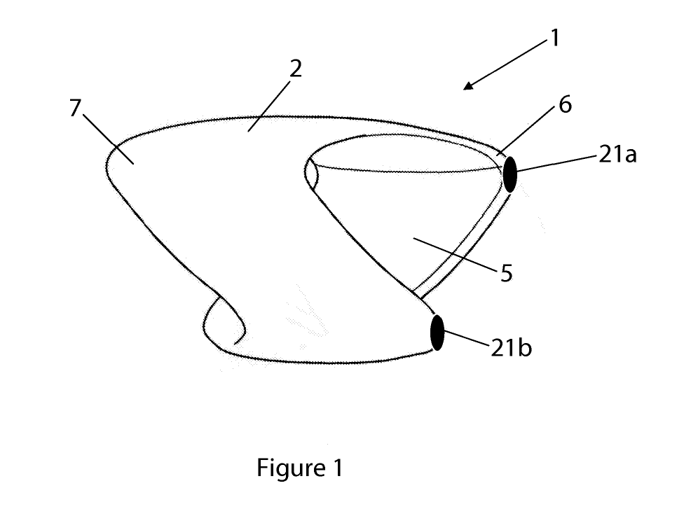

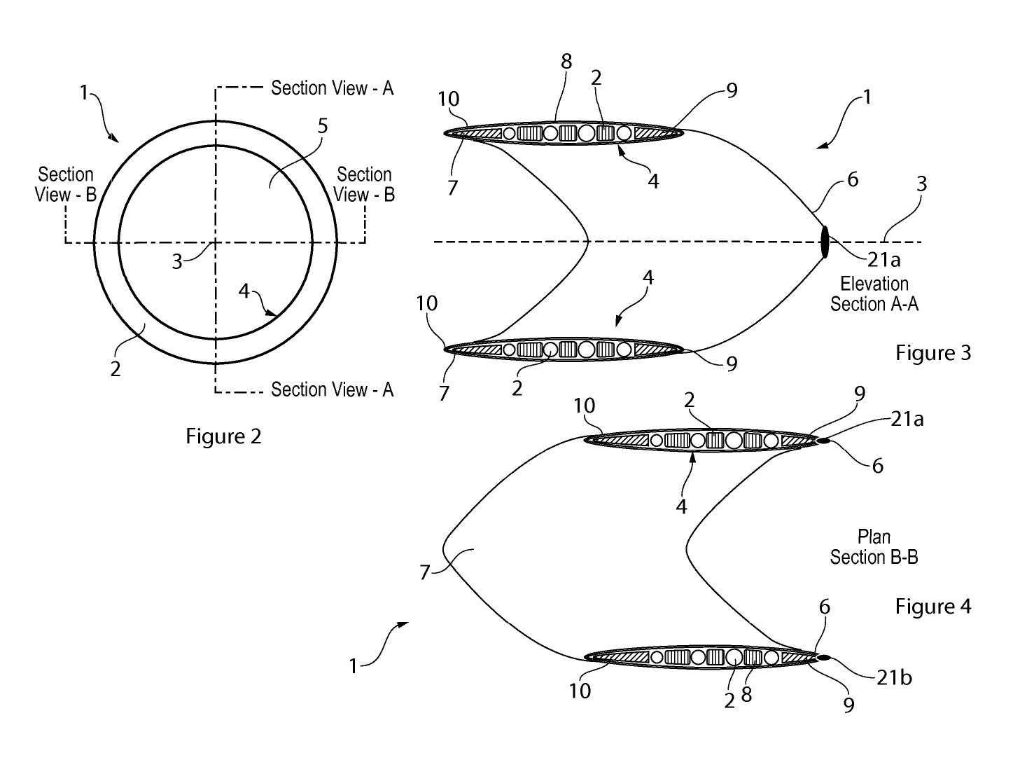

FIGS. 1 to 5 illustrate an annular vehicle 1 having an outer body 2 which is evolved from a laminar flow fluid-foil profile as a body of revolution around a body axis 3. The body 2 appears substantially annular when viewed along the body axis 3 as shown in FIG. 2. An inner surface 4 of the body 2 defines a duct 5 which is opened at both ends (fore and aft) in the direction of the body axis 3.

The annular vehicle 1 defines a bow end 6 and a stern end 7. The fluid-foil profile of the body 2 is arranged to generate lift as the annular vehicle 1 moves through a fluid medium, with the fluid passing through the duct 5 and around the outside of the annular body 2.

The fluid-foil profile, as shown in FIGS. 3 and 4, has a maximum thickness 8 between its leading edge 9 and its trailing edge 10. The fluid-foil profile tapers outwardly gradually from the leading edge 9 nearest the bow end 6 to it maximum thickness point 8, then tapers inwardly to the trailing edge 10 nearest the stern end 7. The fluid foil profile may be symmetric (no camber) or asymmetric, (with camber). The maximum thickness point 8 may be disposed towards the leading edge 9, or towards the trailing edge 10, or may be disposed substantially at the mid-chord of the fluid-foil profile.

In the particular embodiment shown in FIGS. 1 to 4, the body 2 of the annular vehicle 1 is swept with respect to the body axis 3. In particular, the leading edge 9 of the vehicle body 2 describes a closed double chevron sweep around the forward circumference of the body 2. The trailing edge of the body 2 forms an identical closed double chevron sweep which is translated along the body axis 3 by the chord length of the fluid foil, which is substantially constant around the body of revolution. As best shown in FIGS. 3 and 4, the body 2 of the vehicle 1 appears swept backwards when viewed in the side elevation section A-A of FIG. 3, and appears swept forward when viewed in the plan section B-B of FIG. 4. In other embodiments, the leading and trailing edges of the body of the annular vehicle may be un-swept, or only one of the leading and trailing edges may be swept due to a variable fluid-foil chord length around the body of revolution.

The body 2 of the vehicle 1 has an internal volume between inner and outer skins that may be used to house a variety of components, depending on the intended function of the vehicle 1. For example, the body 2 may house batteries, ballast chambers, payload bays, gas storage, electronic equipment, such as wiring routes, processors, data storage devices, communications equipment, etc. These components may be disposed intermediate circumferential structural frames of the body that support the outer skins. The body 2 may be a pressurized or pressurizable hull.

The annular vehicle 1 shown in FIGS. 1 to 4 is an unpowered glider. However, in other embodiments, the vehicle may include one or more propulsion devices for driving the vehicle in the forward and/or aft directions, and/or for rotating the vehicle about the body axis, for example. The propulsion devices may be fixed with respect to the vehicle body or may be configured for vectored thrust.

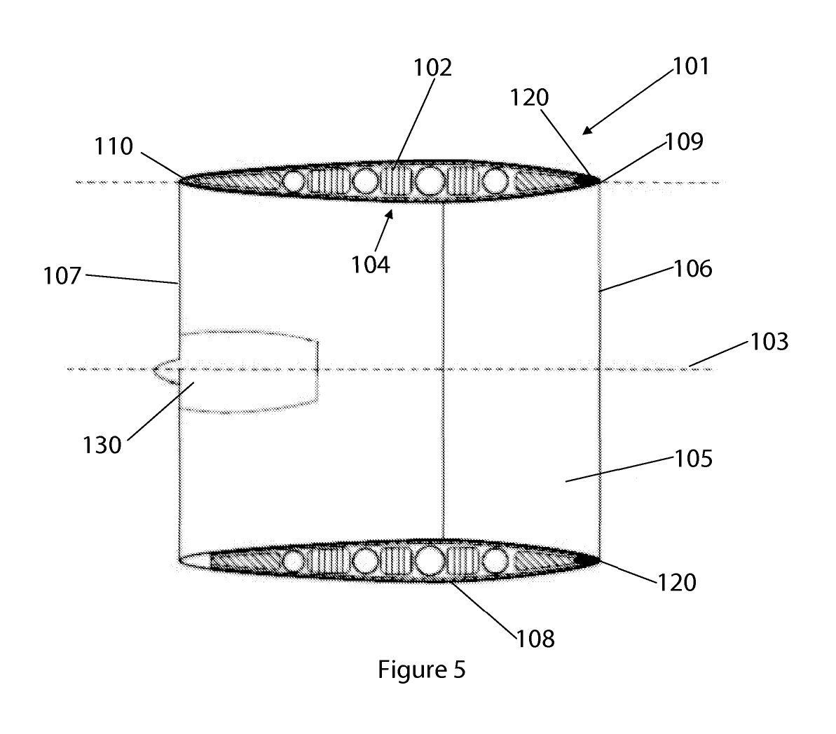

FIG. 5 illustrates another embodiment of the invention in which like reference numerals used in the embodiment of FIGS. 1-4 have been renumbered in the 100 series to denote the same or similar parts. The annular vehicle 101 includes a pair of aft mounted propulsion devices 130 (one shown in the side section view of FIG. 5) mounted within the duct 105. The body 102 of the annular vehicle 101 is un-swept but may alternatively be swept. Whilst in the embodiment shown in FIG. 5 the propulsion devices are disposed within the duct, they may alternatively be disposed outside the body, or alternatively may be embedded within the body structure. In one embodiment the propulsion device(s) include a ducted propeller, but several alternative propulsion device designs well known in the art may similarly be used.

Returning to the embodiment shown in FIGS. 1 to 4, the annular vehicle is a submersible and is configured such that when the vehicle 1 is submerged in a liquid, the liquid floods the duct. In particular, though not exclusively, the vehicle 1 may be used in a sea water environment, which may be a deep sea environment. Alternatively, the vehicle may be used in fresh water.

The vehicle 1 includes an electric field (EF) coupled dipole antenna arrangement 20 for electromagnetic communications. The dipole antenna arrangement includes at least one dipole antenna. As is well known, a dipole antenna generally includes a pair of electrodes spaced a distance apart.

In the embodiment shown in FIGS. 1 to 4, the dipole antenna arrangement 20 includes one dipole antenna 21 having two electrodes 21a, 21b, which are visible in FIG. 1. The electrodes 21a, 21b are disposed within the body 2 at the bow end 6 of the vehicle 1.

The swept vehicle body 2 defines a first pair of apices at the bow end 6 of the vehicle 1 and a second pair of apices, orthogonal to the first, at the stern end 7 of the vehicle. The pair of apices at the bow 6 provide a particularly suitable location for positioning the electrodes 21a, 21b of the dipole antenna arrangement 20. The electrodes are separated by the diameter of the duct 5, and because the first pair of apices project forwardly it becomes possible to axially separate the electrodes 21a, 21b from electro-magnetic sources within the vehicle along the body axis 3. In particular, the electrodes 21a, 21b may be disposed in a region of the vehicle where interference from devices such as batteries, actuators, control electronics and propulsion systems may be minimised.

In addition, the limited volume available within the leading edge 9 of the fluid-foil profile is well utilised by making the electrodes conformal with the leading edge at each apex. The conformal electrodes will reduce drag of the moving vehicle, as compared with electrodes projecting outwardly from the vehicle body shape. At the same time, the contact surface area of the electrodes 21a, 21b with the surrounding fluid medium remains advantageously large due to the shape of the apices of the vehicle body 2.

In one embodiment, the vehicle 1 is an unmanned underwater vehicle (UUV) and the duct 5 has a diameter of approximately 0.5 m such that the vehicle can be launched from a standard torpedo tube. However, the diameter of the duct may vary widely depending of the intended use of the vehicle, whether for airborne or underwater use, manned or unmanned, type of launch system, etc.

Electric field (EF) coupled dipole antennas can provide communications up to around 200 times faster than traditional underwater acoustic communications. Although the range of EF coupled dipole antennas may be much lower than antennas for acoustic communications, the significantly lower latency of communications possible with EF coupled dipole antennas are particularly suitable for some short range communications, e.g. for transferring synchronisation signals between a plurality of nodes in an underwater communications system.

The dipole antenna 21 may be configured to either transmit or receive electric field communications, or alternatively may be configured for selectively switching between transmit and receive operations.

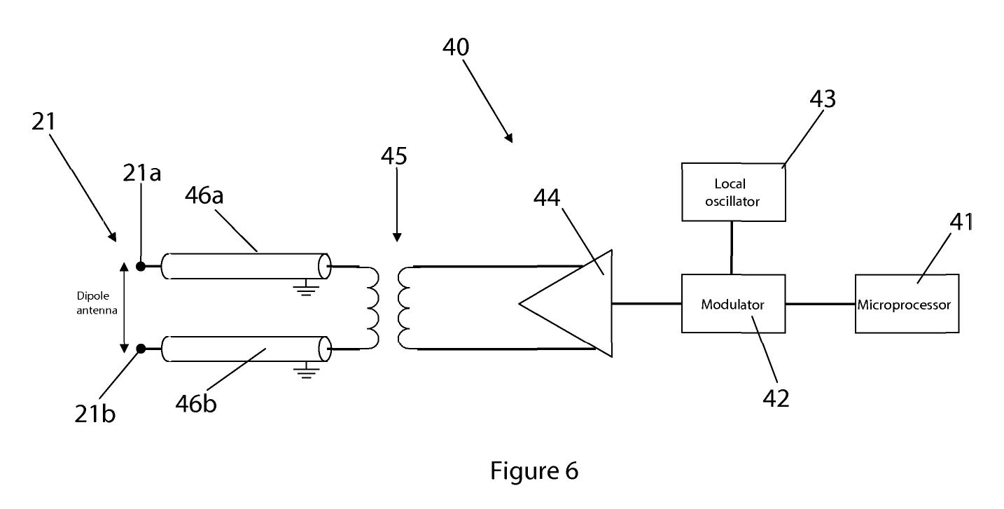

FIG. 6 illustrates a first example of the dipole antenna 21 associated with transmit (only) electronics 40. The transmit electronics 40 include a microprocessor 41 coupled to a modulator 42 associated with a local oscillator 43. The modulator 42 is coupled to a power amplifier 44 and via transformer 45 to a pair of shielded coaxial cables 46a, 46b respectively connected to the electrodes 21, 21b of the dipole antenna 21.

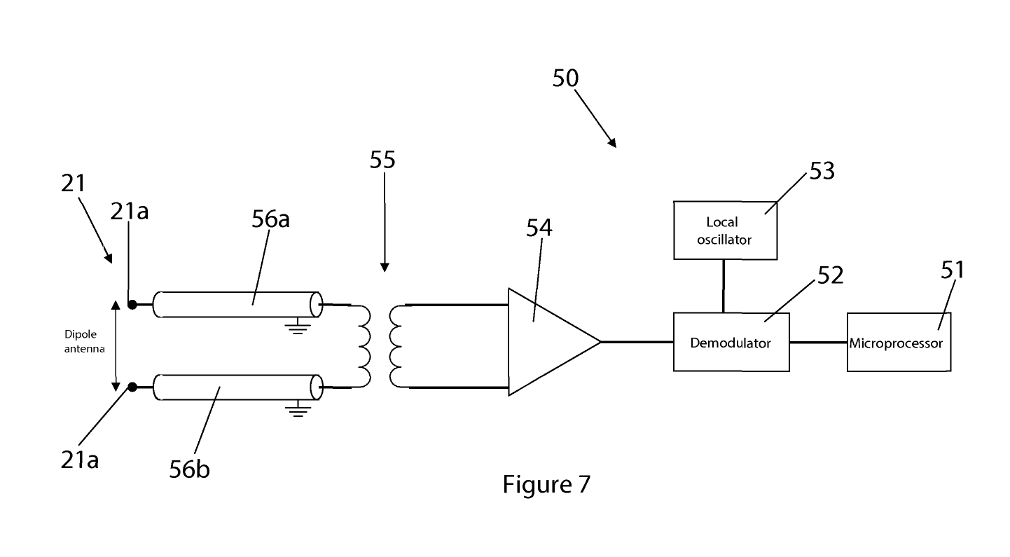

FIG. 7 illustrates a second example of the dipole antenna 21 associated with receive (only) electronics 50. The receive electronics 50 include a microprocessor 51 coupled to a demodulator 52 associated with a local oscillator 53. The demodulator 52 is coupled to a pre-amplifier 54 and via transformer 55 to a pair of shielded coaxial cables 56a, 56b respectively connected to the electrodes 21, 21b of the dipole antenna 21.

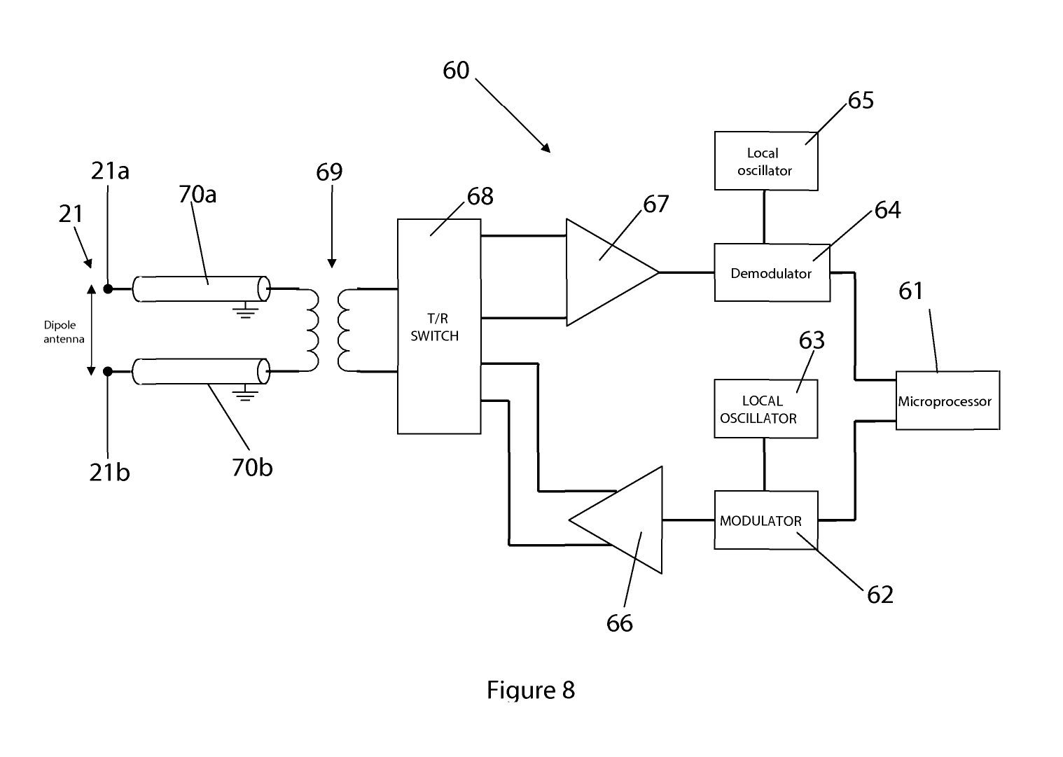

FIG. 8 illustrates a third example of the dipole antenna 21 associated selectively with both receive and transmit electronics 60. The transmit/receive electronics 60 include a microprocessor 61 coupled to a modulator 62 associated with a first local oscillator 63. The microprocessor 61 is also coupled to a demodulator 64 associated with a second local oscillator 65. The modulator 62 is coupled via a power amplifier 64, a transmit/receive switch 68 and a transformer 69 to a pair of shielded coaxial cables 70a, 70b respectively connected to the electrodes 21, 21b of the dipole antenna 21. The demodulator 64 is coupled via a pre-amplifier 67, the transmit/receive switch 68 and the transformer 69 to the pair of shielded coaxial cables 70a, 70b. The dipole antenna 21 is operational in either transmit or receive mode by selectively controlling the switch 68.

The dipole antenna 21 is typically operated in the low frequency (LF) range of radio communications, and more particularly may be operated in the 50 kHz to 100 kHz range for underwater communications. However, it is envisaged that the dipole antenna may alternatively be operated in the very low frequency (VLF) range, or the medium frequency (MLF) range, depending on the communications being effected, and the operational situation of the vehicle.

In one embodiment, the electrodes 21a, 21b are spaced apart by a distance approximately equal to ¼ the wavelength of the communications signal. Depending on the diameter of the annular vehicle 1, the frequency of the communications can be tuned within the desired frequency range. Whilst it would be possible to position the electrodes such that they are not diametrically opposed across the annular vehicle, so as to optimise the antenna performance by varying the dipole spacing, this would depend on the vehicle geometry and for instance would not be particularly suitable with the swept vehicle 1 shown in FIGS. 1 to 4. Where positioning of the electrodes is more constrained, tuning the frequency to achieve good antenna performance is more likely to be suitable.

With the vehicle submerged in a fluid medium such as water, the electrodes will be coupled with the fluid. The power rating of the dipole antenna 21 is therefore relatively low due to the closed path through the fluid and a voltage of approximately 3V, for example, may be appropriate.

The low power requirements of the dipole antenna are not particularly disadvantageous as compared with a loop antenna, for example, which also requires a low power rating to avoid interference with nearby electronic systems. Moreover, a loop antenna would be more susceptible from interference from running motors (such as may be found in the propulsion devices for the vehicle), and loop antennas typically suffer blind spots and have a high space requirement which would not package well with an annular vehicle. These factors have been found to promote particular synergy between an annular vehicle and a dipole antenna arrangement.

The electrodes 21a, 21b are preferably made of brass or bronze but may be made of any other suitable material. Anti-corrosion measures are put in place to mitigate the effects of coupling the electrodes 21a, 21b with the fluid medium. For example, the electrodes are AC coupled rather than DC coupled, and the electrodes may also be covered with a layer of dielectric material. The electrodes 21a, 21b are also made removable from the vehicle 1. This enables easy maintenance and/or repair of the electrodes.

The dielectric material covering the electrodes may have an impedance selected to substantially match the impedance of the fluid medium in which the vehicle is intended to operate. For example, the impedance of sea water varies with salinity, typically between 2 ′Ω to 10 ′Ω. The dielectric material may be made of a plastics material, for example, and may be provided as a cap, or cover, over the electrodes.

The coaxial cables, shown in FIGS. 6 to 8 coupling the electrodes 21a, 21b to the various implementations of their control electronics 40, 50, 60, extend substantially circumferentially around the duct 5 within the body 2.

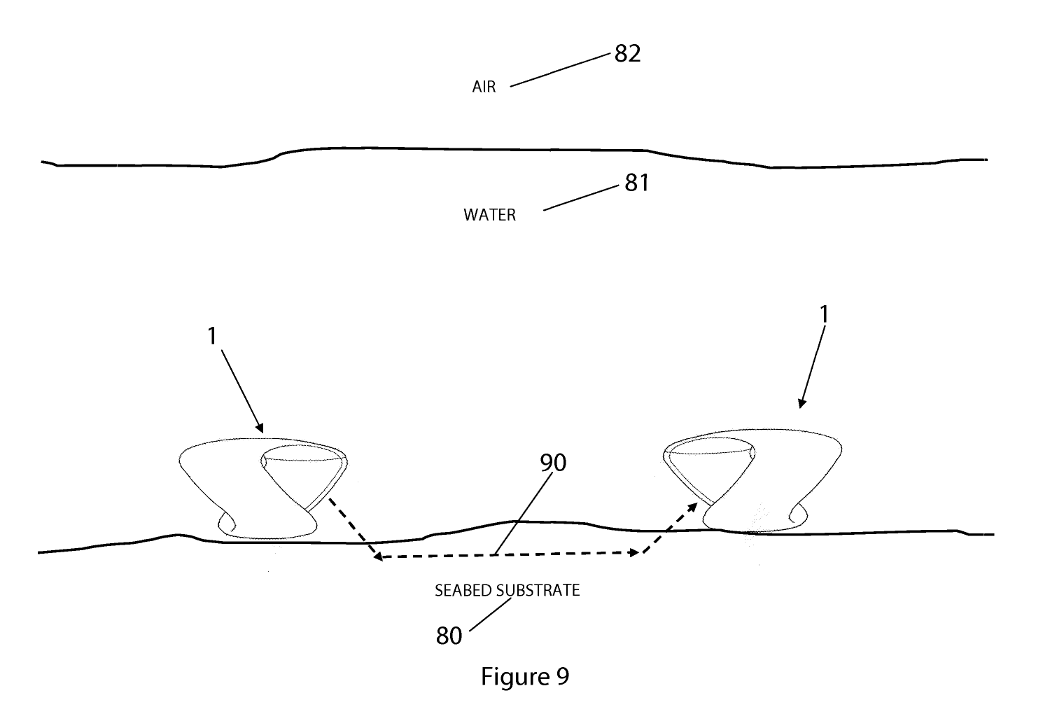

The vehicle 1 may be used as a node within a communications system. FIG. 9 illustrates two of the vehicle 1 described above with reference to FIGS. 1 to 4 used in an underwater communications system. The vehicles 1 rest on or are disposed near the sea bed substrate 80 beneath a body of sea water 81 with air 82 above. The vehicles 1 make communications using their respective dipole antenna arrangements via a communications path 90 predominantly through the sea bed substrate 80. The sea bed substrate 90 supports a viable communications channel over a distance of up to approximately 50 m-150 m.

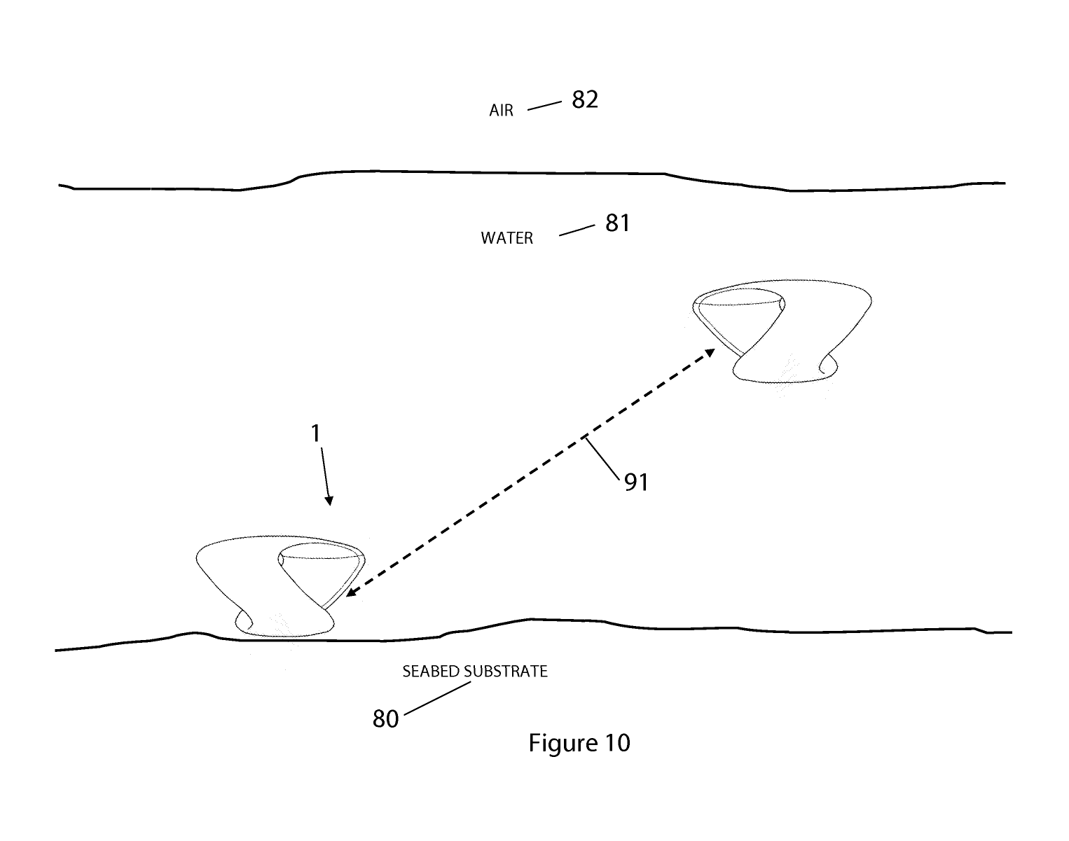

Communications predominantly through the sea bed substrate 80 using the “skin effect” compares particularly favourably with a communications path 91 predominantly through the ‘blue water’ alone, such as shown in FIG. 10, which can typically support a viable communications channel over a distance of up to approximately 15 m-25 m between two nodes—in this case two of the vehicles 1. One of the vehicles 1 is a static node on the sea bed and the other vehicle 1 is a ‘swimming’ node moving through the water column.

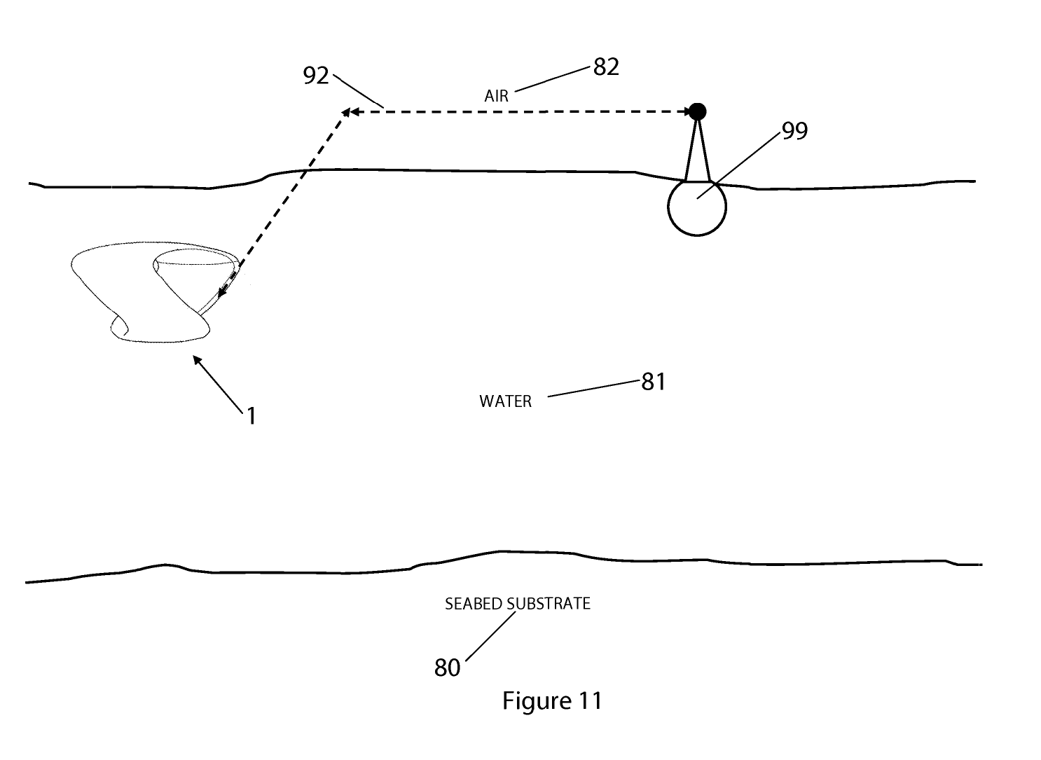

FIG. 11 illustrates a further implementation in which the communications system includes a first node which is the vehicle 1 and a second node which is a communications buoy 99. The communications buoy 99 has an EF coupled dipole antenna for making communications with the vehicle 1. The vehicle 1 is disposed adjacent the surface of the water 81 but still partially or fully submerged. In this case, the vehicle 1 and the buoy 99 make communications using their respective dipole antenna arrangements via a communications path 92 predominantly through the air 82. The air/sea skin effect can support a viable communications channel over a distance of up to approximately 50 m-150 m.

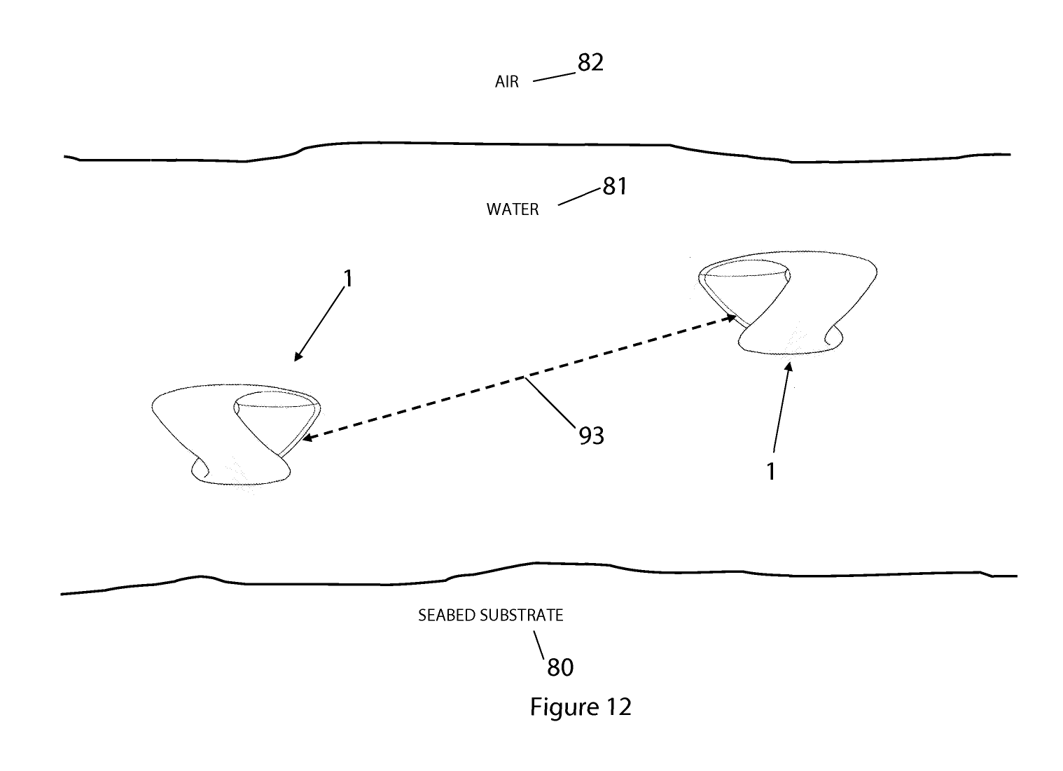

FIG. 12 illustrates a yet further implementation in which the communications system includes two nodes which are the vehicles 1 and communicate solely via the ‘blue water’ lossy medium using communications path 93. In this scenario both of the vehicles 1 are ‘swimming nodes’ moving through the water column.

It will be appreciated that the exemplary communications between nodes in a communications system shown in FIGS. 9 to 12 may be combined in a larger communications system comprising a plurality of nodes. The nodes may include one or more static nodes, one or more swimming nodes and/or one or more surface nodes. The static node(s) and swimming node(s) may be the annular vehicles 1 described above and the surface node(s) may be the buoy 99.

The static node(s) may be positioned on the sea bed by ‘flying’ the annular vehicle into the sea bed so as to be partially embedded in the sea bed. The nodes may be launched from a surface vessel, and subsequently recovered to the vessel.

The direction of the communications between the various nodes will depend on the configuration of each node. For example, each node may include one or more dipole antennas, and each antenna may be configured for transmit or receive operations only, or may be configured for selectively switching between transmit and receive operations using control electronics as described above with respect to FIGS. 6 to 8.

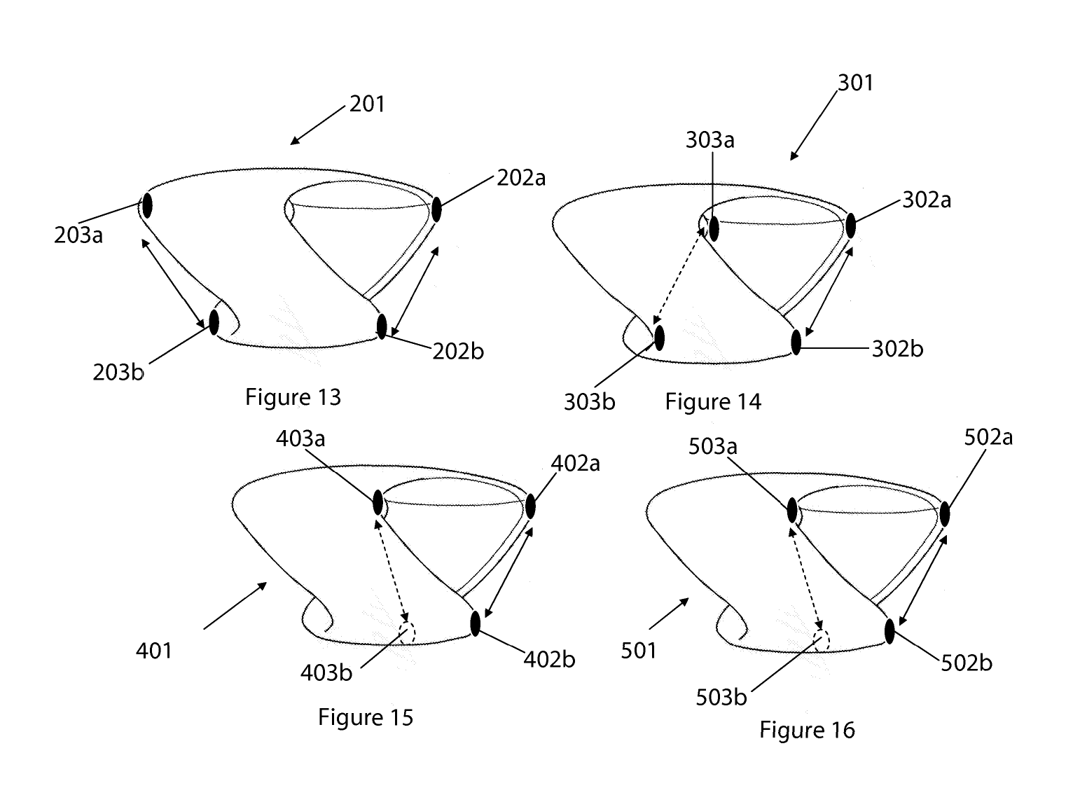

FIGS. 13 to 16 illustrate variants of the vehicle 1 described above with reference to FIGS. 1 to 4 and differ only by their EF coupled dipole antenna arrangements. In all other respects the vehicles are as described above.

The vehicle 201 illustrated in FIG. 13 has a first dipole antenna with electrodes 202a, 202b disposed at the apices at one end of the vehicle and a second dipole antenna with electrodes 203a, 203b at the apices at the other end of the vehicle. Due to the swept configuration of the annular vehicle, the first and second dipole antennas are arranged orthogonally. The first and second antennas may be transmit and receive antennas respectively or vice versa. The orthogonal relationship between the antennas avoids interference during concurrent communications with the two antennas.

The vehicle 301 illustrated in FIG. 14 has a first dipole antenna with electrodes 302a, 302b disposed at the apices at one end of the vehicle and a second dipole antenna with electrodes 303a, 303b at the re-entrant apices at the other end of the vehicle. The first and second dipole antennas are arranged parallel.

The vehicle 401 illustrated in FIG. 15 has a first dipole antenna with electrodes 402a, 402b disposed at the apices at one end of the vehicle and a second dipole antenna with electrodes 403a, 403b at the re-entrant apices at the same end of the vehicle. The first and second dipole antennas are arranged orthogonal. The swept annular vehicle body provides sufficient axial separation between the apices and re-entrant apices at the same end of the vehicle. In the case where both the first and second antennas are receive antennas it becomes possible to effect passive three-dimensional imaging. In one embodiment, the first and second antennas are disposed at the front of the vehicle.

The vehicle 501 illustrated in FIG. 16 is similar to the vehicle 401 of FIG. 15 with the exception that the first antenna is a transmit antenna and the second antenna is a receive antenna.

The dipole antenna arrangements described above are provided purely as examples and other variants of the antenna arrangements will be appreciated by those skilled in the art.

Although the invention has been described above with reference to one or more preferred embodiments, it will be appreciated that various changes or modifications may be made without departing from the scope of the invention as defined in the appended claims.

1. An annular vehicle having a body which defines a body axis and appears substantially annular when viewed along the body axis, the interior of the annulus defining a duct which is open at both ends, and an electric field coupled dipole antenna arrangement for electro-magnetic communications which includes at least one dipole antenna.

2. A vehicle according to claim 1, wherein the vehicle is a submersible and is configured such that when the vehicle is submerged in a liquid, the liquid floods the duct.

3. (canceled)

4. A vehicle according to claim 1, wherein the at least one dipole antenna has separated electrodes disposed on opposite sides of the duct.

5. (canceled)

6. (canceled)

7. (canceled)

8. A vehicle according to claim 4, wherein the electrodes of the at least one dipole antenna are covered by a dielectric material.

9. (canceled)

10. A vehicle according to claim 4, wherein the at least one dipole antenna has a coaxial cable extending substantially circumferentially around the duct.

11. (canceled)

12. A vehicle according to claim 1, wherein the dipole antenna arrangement includes a plurality of dipole antennas.

13. (canceled)

14. (canceled)

15. (canceled)

16. A vehicle according to claim 1, wherein the dipole antenna arrangement includes one or more dipole antennas disposed at an end of the duct.

17. A vehicle according to claim 1, wherein the body axis defines a longitudinal axis in the direction of forward travel of the vehicle, and the dipole antenna arrangement includes one or more dipole antennas disposed at the forward end of the vehicle.

18. A vehicle according to claim 1, wherein at least part of the body is swept with respect to the body axis.

19. A vehicle according to claim 18, wherein the swept annular body forms a pair of diametrically opposed apices at each end of the vehicle.

20. A vehicle according to claim 19, wherein each pair of diametrically opposed apices are spaced by a distance of approximately 0.1 m to 1 m.

21. A vehicle according to claim 19, wherein the one or more dipole antennas each have separated electrodes, and wherein each dipole is associated with a respective one of the diametrically opposed apices of the vehicle such that the separated electrodes are disposed at the opposing apices.

22. A vehicle according to claim 19, wherein the annular body is swept such that the diametrically opposed apices at each end of the vehicle are oriented orthogonally.

23. A vehicle according to claim 1, wherein the dipole antenna arrangement is configured for electro-magnetic communications at a carrier frequency in the range 10 kHz to 1000 kHz, preferably in the range 50 kHz to 100 kHz.

24. (canceled)

25. An underwater communications system comprising a plurality of nodes, wherein each node is an annular vehicle in accordance with claim 1, and wherein each node is operable to communicate with at least one other node using their electric field coupled dipole antenna arrangements.

26. (canceled)

27. A method of operating an underwater communications system comprising a plurality of nodes, at least some of the nodes being annular vehicles each having a body which defines a body axis and appears substantially annular when viewed along the body axis, the interior of the annulus defining a duct which is open at both ends, and an electric field coupled dipole antenna arrangement which includes at least one dipole antenna, the method comprising making electro-magnetic communications between the nodes using their electric field coupled dipole antenna arrangements.

28. A method according to claim 27, wherein the plurality of nodes includes a plurality of static nodes on the sea bed, and the method further comprises making communications between the static nodes via a signal path predominantly through the sea bed.

29. A method according to claim 27, wherein the plurality of nodes includes at least one static node on the sea bed and at least one swimming node, and the method further comprises making communications between the static node and the swimming node via a signal path predominantly through the sea water.

30. A method according to claim 27, wherein the plurality of nodes includes at least one swimming node and at least one above water surface node, and the method further comprises making communications between the swimming node and the surface node via a signal path that includes an air propagation path.

31. A method according to claim 27, wherein the plurality of nodes includes at least one static node on the sea bed, and the method further comprises positioning the static node on the sea bed by flying the annular vehicle into the sea bed so as to be partially embedded in the sea bed.

32. (canceled)
